(19) United States
(12) Patent Application Publication
(10) Pub. No.: US 2010/0286904 A1
(43) Pub. Date: Nov. 11, 2010

(54) DEVICE ASSEMBLY FOR PERFORMING A DRIVER ASSISTANCE FUNCTION

(76) Inventors: Manfred Meissner, Vaihingen/Enz (DE); Holger Janssen, Hessisch Oldendorf (DE); Wolfgang Niehsen, Bad Salzdetfurth (DE); Jochen Wingbermuehle, Hemmingen (DE); Jens Schick, Herrenberg (DE); Andreas Reppich, Leonberg (DE)

Correspondence Address: KENYON & KENYON LLP, ONE BROADWAY, NEW YORK, NY, 10004, US

(21) Appl. No.: 12/734,040

(22) PCT Filed: Sep. 11, 2008
(86) PCT No.: PCT/EP2008/062065

§ 371 Date: Jul. 26, 2010

(30) Foreign Application Priority Data
Oct. 10, 2007 (DE) 102007048605.9
Nov. 30, 2007 (DE) 102007057744.5

(51) Int. Cl. B60R 11/04; H04N 7/18; G01C 21/26

(52) U.S. Cl. 701/200; 348/148; 348/118; 348/E07.085

(57) ABSTRACT

A device assembly for performing a driver assistance function includes a mobile terminal, and a holder removably installed in the vehicle for temporarily receiving the mobile terminal. At least one image recording device is connected to the holder and, to support the performance of the driver assistance function, is connectable to the mobile terminal via an image signal line and at least one first electrical interface situated in the holder when the holder receives the mobile terminal for performing the driver assistance function.

### BACKGROUND OF THE INVENTION

1. Field of the Invention

The present invention relates to a device assembly for performing a driver assistance function.

2. Description of Related Art

Different driver assistance systems are known from the related art. Vehicle systems such as, for example, night vision devices, lane recognition systems, traffic sign recognition systems, back-up support systems, vehicle recognition systems, etc., which use electronic cameras or image recording devices having an image recording sensor, are known. The image recording sensor is designed, for example, as a CCD or CMOS sensor chip, which is evaluated by a high-performance computer unit for image processing.

For video-based monitoring of the surroundings of the vehicle and for implementing the driver assistance functions, in addition to cameras fixedly installed in the vehicle, out-of-line, retrofittable camera modules may also be used. For these camera modules, wireless image transmission to an optical display unit viewable by the driver may be used for performing display functions. Power may be supplied by a battery pack, for example. Mobile terminals such as computers, personal digital assistants (PDAs), cell phones, etc., may be used, for example, as optical display units. However, the out-of-line camera modules may result in a higher complexity in the vehicle for their installation, wiring, and power supply.

In addition, mobile terminals such as computers, PDAs, cell phones, etc., having an integrated image recording device may be used for video-based driver assistance functions. However, in these mobile terminals, the positioning of the integrated image recording device is problematic. To cover the viewing range required for the driver assistance functions, the image recording device must be fastened within a certain spatial range and an appropriate viewing direction must be oriented within a tolerance. However, meeting these requirements may, on the one hand, limit the readability of the optical display unit and the operability of the mobile terminal by the driver. In addition, a fine adjustment by the user is required after each removal of the mobile terminal from and reinstallation into the vehicle. Furthermore, in the design of the mobile terminal, a similarly suitable position of the image recording device is usually provided on the housing side opposite the optical display unit. In addition, conventional mobile navigation devices or other mobile terminals are usually removed from the vehicle during longer interruptions in travel, for example overnight, whereby the frequent fine adjustment required each time the mobile terminal is reinstalled represents a potential nuisance for the user.

U.S. Pat. No. 5,246,193, for example, describes a holder for a mobile camera. The described holder is threaded onto the mobile camera and attached to a vehicle windshield via suction attachment devices.

In addition, published German patent document DE 102 09 615 A1 describes a device and a method for permanently attaching a sensor means to a vehicle windshield.

The device assembly according to the present invention for performing a driver assistance function, having the features of independent Patent Claim 1, has the advantage over the related art that at least one image recording device is connected to a holder, in particular removably installed in the vehicle, which temporarily receives a mobile terminal. To support the performance of the driver assistance function, the image recording device is connectable to the mobile terminal via an image signal line and at least one first electrical interface situated in the holder when the holder receives the mobile terminal for performing the driver assistance function. The device assembly according to the present invention advantageously enables an approach acceptable to the user for implementing displaying and analyzing driver assistance functions on mobile terminals. Images are transmitted between the image recording device and the mobile terminal via the image signal line and the first interface, usually more interference-free than in the case of wireless signal transmission. Since only the mobile terminal is removed from the holder, the repeated effort for fine adjustment of the image recording device is no longer needed due to the image recording device which remains in the holder and is attached thereto.

It is advantageous in particular that the holder is connected to a power supply unit via a power supply line, the power supply line being connectable to the image recording device and, via a second electrical interface, to the mobile terminal. This makes it possible for the image recording device to advantageously also use a power supply present in the holder for the mobile terminal without the user having to incur additional wiring expense. The image recording device is connected to the holder mechanically fixedly or in a lockable manner.

In an embodiment of the device assembly according to the present invention for performing a driver assistance function, the holder may be designed, for example, as a suction attachment device and attached to a vehicle windshield. Alternatively, the holder may be attached to the dashboard.

In another embodiment of the device assembly according to the present invention, the image recording device is integrated into the holder or connected to the holder via an attachment arm. The holder receives the mobile terminal, for example, in a receptacle well. Alternatively, the holder may receive the mobile terminal via a receptacle arm.

In another embodiment of the device assembly according to the present invention, an image processing unit, which may perform image signal analysis, image signal processing, and/or image signal conversion, is embedded in the holder between the image recording device and the first interface.

The mobile terminal performs a navigation assistance function and/or a lane recognition assistance function and/or a night vision assistance function and/or a high beam assistance function, for example.

### BRIEF DESCRIPTION OF SEVERAL VIEWS OF THE DRAWING

FIG. 1 shows a schematic block diagram of a first exemplary embodiment of a device assembly according to the present invention for performing a driver assistance function.

FIG. 2 shows a schematic block diagram of a second exemplary embodiment of a device assembly according to the present invention for performing a driver assistance function.

FIG. 3 shows a schematic block diagram of a third exemplary embodiment of a device assembly according to the present invention for performing a driver assistance function.

FIG. 4 shows a schematic block diagram of a fourth exemplary embodiment of a device assembly according to the present invention for performing a driver assistance function.

### DETAILED DESCRIPTION OF THE INVENTION

In the figures, the same reference numerals identify the same elements or components performing the same or similar functions.

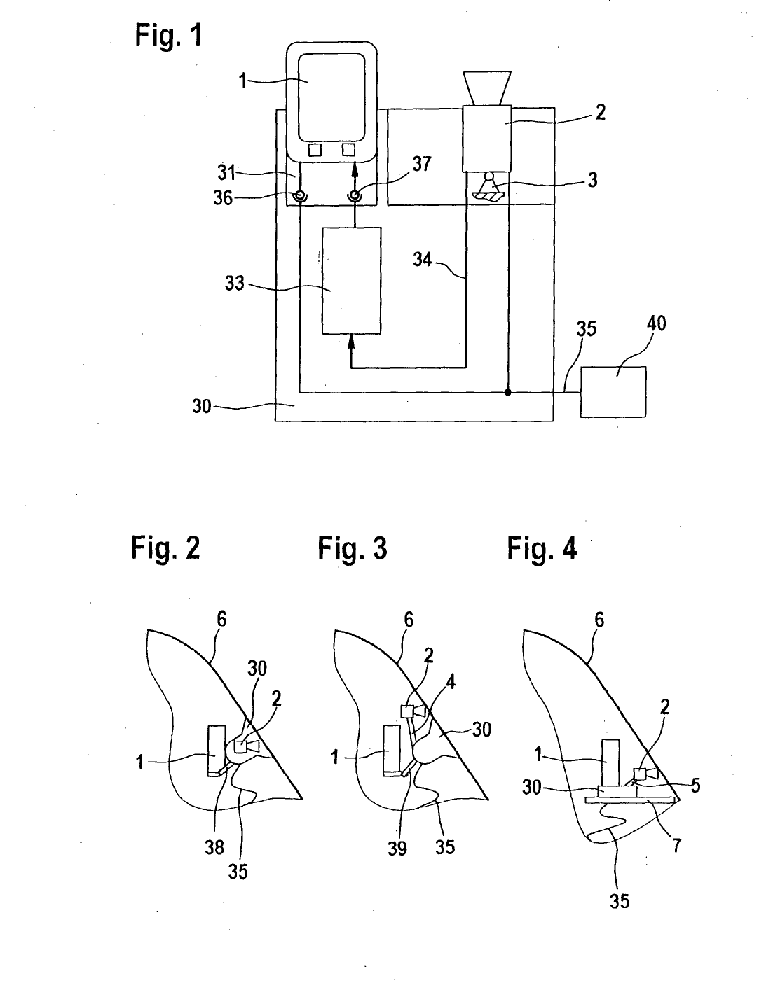

As is apparent from FIG. 1, a first exemplary embodiment of a device assembly according to the present invention for performing a driver assistance function includes a mobile terminal 1 and a holder 30, removably installed in the vehicle for temporarily receiving mobile terminal 1. Holder 30 may be attached to a vehicle windshield or to a dashboard in the vehicle. Mobile terminal 1 may perform a navigation assistance function and/or a lane recognition assistance function and/or a night vision assistance function and/or a high beam assistance function, for example. In the first illustrated exemplary embodiment, an image recording device 2, which includes a CCD or CMOS sensor chip, for example, is integrated into holder 30 for mobile terminal 1 and is fixedly connected to holder 30 via a lock 3, image recording device 3 being able to swivel about an axis of rotation for setting the viewing range and for fine adjustment. To perform the driver assistance function, mobile terminal 2 is inserted into the holder via a receptacle well 31. To support the performance of the driver assistance function, image recording device 2 is connected to mobile terminal 1 via an image signal line 34 and a first electrical interface 37 situated in holder 30. Furthermore, in the illustrated exemplary embodiment, an image processing unit 33, which adapts and/or converts and/or processes the image signals of the image recording device for the application in mobile terminal 1, is embedded between image recording device 2 and first interface 37. As is furthermore apparent from FIG. 1, holder 30 is connected to a power supply unit 40 via a power supply line 35. The vehicle electrical system may be used, for example, as power supply unit 40. In the illustrated exemplary embodiment, power supply line 35 is directly connected to image recording device 2 within holder 30 and may be connected to mobile terminal 1 via a second electrical interface 36 when the mobile terminal is inserted into receptacle well 31.

Further example embodiments of the device assembly according to the present invention are described below with reference to FIGS. 2 through 4.

As is apparent from FIG. 2, holder 30 according to the second exemplary embodiment is designed as a suction attachment device and is attached to a vehicle windshield 6. According to the second exemplary embodiment, image recording device 2 is integrated into the suction cup of holder 30 designed as a suction attachment device. As is further apparent from FIG. 2, holder 30 receives mobile terminal 1 via a receptacle arm 38, in which the appropriate interfaces (not illustrated) for transmitting the image signals and for the power supply are situated, power being supplied to image recording device 2 and mobile terminal 1 via power supply line 35, similarly to the first exemplary embodiment.

As is apparent from FIG. 3, holder 30 according to the third exemplary embodiment is designed as a suction attachment device, similarly to the second exemplary embodiment, and is attached to vehicle windshield 6. Furthermore, holder 30 receives mobile terminal 1 via a receptacle arm 39 in which the appropriate interfaces (not illustrated) for transmitting the image signals and for the power supply are situated. Unlike in the second exemplary embodiment, image recording device 2 is fixedly connected to holder 30 designed as a suction attachment device via an attachment arm 4. Power is supplied to image recording device 2 and mobile terminal 1 via power supply line 35, similarly to the first and second exemplary embodiments.

As is apparent from FIG. 4, holder 30 according to the fourth exemplary embodiment is attached to dashboard 7. Similarly to the first exemplary embodiment, holder 30 receives mobile terminal 1 via a receptacle well (not illustrated), in which the appropriate interfaces (not illustrated) for transmitting the image signals and for the power supply are situated. Similarly to the third exemplary embodiment, image recording device 2 is fixedly connected to holder 30 via an attachment arm 5. Power is supplied to image recording device 2 and mobile terminal 1 via power supply line 35, similarly to the other exemplary embodiments.

In a further example embodiment, a device assembly according to the present invention for performing a driver assistance function includes a mobile navigation device as a mobile terminal and also a holder, in particular a removable holder, in particular removably installed in the vehicle for temporarily receiving the mobile navigation device. The mobile navigation device provides functions for navigation such as displays for orienting and routing the driver and/or displaying stored traffic signs. In this further exemplary embodiment, an image recording device, in particular a CCD or CMOS camera, as well as a baffle, is attached to the holder. The baffle is designed in such a way that the incidence of stray light into the image recording device is reduced. In a variant of this exemplary embodiment, the holder includes a suction cup, which is used for attaching the holder to the windshield of the vehicle, the image recording device being integrated into the suction cup in such a way that the suction cup acts as a baffle. To perform the driver assistance function, the mobile navigation device is also inserted into the holder via a receptacle well. Furthermore, the image recording device is connected to the mobile navigation device via an image signal line and a first electrical interface situated in the holder, an image processing unit, which adapts and/or converts and/or processes the image signals of the image recording device for the application in the mobile navigation device, being embedded between the image recording device and the first interface. The device assembly provides camera-based driver assistance functions, the displays and operating controls of the mobile navigation device being the man-machine interface of the driver assistance functions. In this exemplary embodiment, the device assembly according to the present invention provides display-type driver assistance functions such as lane recognition assistance function and/or night vision assistance function and/or traffic sign display assistance function and/or non-display-type driver assistance functions such as the high-beam assistance function. In this exemplary embodiment, the image recording device is oriented in the vehicle in such a way that the image recording device has forward vision through the windshield. In a variant of this exemplary embodiment, the image recording device is designed as a stereo camera. In another variant of this exemplary embodiment, an image recording device with backward vision, i.e., a back-up camera, is additionally connected to the mobile navigation device. The back-up camera is preferably connected to the mobile navigation device via a wireless interface, in particular a Wireless Local Area Network (WLAN) interface. Alternatively or additionally, the data link between the back-up camera and the mobile navigation device takes place wire-bound. In a further variant of this exemplary embodiment, the mobile navigation device is connected to other vehicle control units preferably via a wireless interface.

This wireless interface is designed in particular as a WLAN interface. The wireless interface is used for receiving and/or transmitting and/or exchanging vehicle data such as, for example, vehicle velocity, steering angle, set gear such as reverse, external temperature, wheel slip, and/or weather conditions such as rain. Some or all of these data are either displayed to the driver of the vehicle by the mobile navigation device or the data are used in providing the driver assistance function. For example, in this exemplary embodiment, the mobile navigation device is displaying the external temperature. Furthermore, in this exemplary embodiment, the vehicle velocity is taken into account when providing the driver assistance function “lane recognition assistance function.”

The device assembly according to the present invention for performing a driver assistance function represents an option for implementing video-based driver assistance functions on mobile terminals. The mobile terminal may be easily removed and reinstalled without modifying the orientation or position of the other components. The device assembly according to the present invention thus makes it possible to insert navigation instructions into a live video image. The present invention is not limited to mobile navigation devices, but the mobile terminal may also be a personal digital assistant (PDA) and/or a cell phone.

1-14. (canceled)

15. A device assembly for performing a driver assistance function in a vehicle, comprising:
a mobile terminal;
a holder installed in the vehicle for temporarily receiving the mobile terminal; and
at least one image recording device connected to the holder, wherein the image recording device is selectively connectable to the mobile terminal via an image signal line and at least one first electrical interface situated in the holder in order to support the performance of the driver assistance function when the holder receives the mobile terminal for performing the driver assistance function.

16. The device assembly as recited in claim 15, wherein the holder is connected to a power supply unit via a power supply line, and wherein the power supply line is connectable to the image recording device and, via a second electrical interface, to the mobile terminal.

17. The device assembly as recited in claim 16, wherein the image recording device is connected to the holder in a mechanically fixed manner.

18. The device assembly as recited in claim 17, wherein the holder is configured as a suction attachment device and is attached to a vehicle windshield.

19. The device assembly as recited in claim 17, wherein the holder is attached to a vehicle dashboard.

20. The device assembly as recited in claim 16, wherein the image recording device is one of integrated into the holder or connected to the holder via an attachment arm.

21. The device assembly as recited in claim 17, wherein the holder receives the mobile terminal in a receptacle well.

22. The device assembly as recited in claim 17, wherein the holder receives the mobile terminal via a receptacle arm.

23. The device assembly as recited in claim 17, further comprising:
an image processing unit provided in the holder between the image recording device and the first electrical interface.

24. The device assembly as recited in claim 23, wherein the mobile terminal performs at least one of a navigation assistance function, a lane recognition assistance function, a night vision assistance function, and a high beam assistance function.

25. The device assembly as recited in claim 17, wherein the holder is removable from the vehicle.

26. The device assembly as recited in claim 18, wherein the image recording device is integrated into a suction cup of the suction attachment device.

27. The device assembly as recited in claim 24, wherein the mobile terminal is a mobile navigation device.

28. The device assembly as recited in claim 24, wherein the mobile terminal is connected to at least one of a vehicle control unit and another image recording device of the vehicle for data transmission via a wireless interface.
